(19) United States
(12) Patent Application Publication
(10) Pub. No.: US 2009/0223127 A1
(43) Pub. Date: Sep. 10, 2009

(54) SELF WATER PLANT CONTAINER

(76) Inventors: John Herbert Brown, Suffolk (GB); Andrew John Elsey, Suffolk (GB); Haydn James Kerby, Suffolk (GB)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 12/281,013

(22) PCT Filed: Feb. 28, 2007
(86) PCT No.: PCT/GB07/00688

§ 371 Date: Jan. 26, 2009

(30) Foreign Application Priority Data
Feb. 28, 2006 (GB) 0604027.3

(51) Int. Cl. A01G 27/00

(52) U.S. Cl. 47/66.7; 47/79; 47/67

(57) ABSTRACT

A plant watering apparatus has a container (1) filled with a suitable growth medium (2) and is attached to a foliage support plate (3) by a bar (4) operatively coupled with a spring loaded water control valve (6). Decreasing weight of the container opens the valve to feed water to container. The plate (3) is supported by a wall or ceiling bracket (10) by means of suspension rods (11). Plants (12) are added through holes (14) in the plate (3) and the plant root ball (13) is embedded within the medium (2) with the plant foliage overlying the plate (3). When sufficient water is present in the container 1 the spring loaded valve 6 will be closed. As the medium (2) in the container dries out the weight will reduce and the valve will commence opening. The foliage is supported by the plate (3) and foliage growth will not significantly add to the weight of the container and thus will not affect the operating point of the valve over extended periods of time.

This invention relates to a plant watering apparatus and more particularly to the automatic watering of plant containers using valves activated by weight change in the planted medium within the container.

Known arrangements include a water container suspended by a spring device operatively coupled with a valve means which is actuated when the overall weight of the container, that is the total weight of the container and plant, reduces to a predetermined level to permit water flow to the container. The valve is then closed when the weight is restored to a predetermined value. Other known arrangements include capillary tubes to provide constant dripping so as to maintain an equilibrium but such systems are difficult to calibrate and suffer from blockages due to impurities in the water and calcification.

A disadvantage of these known arrangements is that an increase in the weight of the plant itself, such as that due to foliage growth, upsets the balance and has the effect of reducing or stopping the watering action as the valve means remains closed. These systems cannot therefore be used over extended periods without readjustment.

An object of this invention is to provide a method and apparatus for plant watering which functions automatically using the plant container weight for controlling water flow and which is substantially independent of weight increase due to foliage growth.

According to this invention there is provided a plant watering apparatus wherein a plant container is associated with valve means controlling the flow of water to the container according to a change in container weight, characterised by the provision of a plant foliage support member. In use a greater part of the weight of plant foliage from growth of plants in the container will thus be carried by the support member and does not contribute to the weight of the container over an extended period of time.

The plant foliage support member may comprise an apertured plate through which foliage from plants in the container may pass such that a greater part of the weight of the foliage is carried by the plate by which means the foliage and thus the plate will not contribute to the weight of the container and will thus not affect the control of the water flow.

In an embodiment the plant container, or a supporting member for such a container, is suspended and operatively associated with the valve means such that the valve is opened to permit water flow to the container as the container becomes lighter due to water loss. Conversely an increase in weight of the container tends to close the valve thus shutting off the water flow.

The plant support member is mounted or suspended independently of the container. Thus the weight and that of the foliage does not contribute to the overall weight of the container.

In one preferred embodiment the container is suspended from the plant foliage support member in a manner whereby relative displacement actuates the water control valve means which may be mounted on the container or on the support plate. In this case the plant foliage support is adapted to be supported or suspended from a fixed structure such as a wall or ceiling. The valve means may be fed with water through a pipe from a supply or may include a water container mounted on the support plate.

The container may be suspended from a rod operatively coupled with the valve located within a housing on the support plate. The container is preferably supported through spring means permitting displacement, relative to the plate, according to weight. The spring means may be an integral part of the valve.

The operative points of opening and closing of the valve may be adjustable and conveniently effected by adjustment of the valve position in relation to the container support rod.

This invention also provides a method of watering a plant in a container in which method a water flow valve controls flow of water to the container in response to a change in the weight of the container, the method including the step of supporting plant foliage such that the increasing weight thereof is not borne by the container.

In contrast to known devices the apparatus of this invention is not influenced to any great extent by the increasing weight of the plant foliage, which varies with growth. In this invention it is solely or predominantly only the weight change of the root ball and planting medium within a container which controls the watering operation.

This invention is further described and illustrated with reference to the following description and drawings showing an embodiment by way of an example. In the drawings:

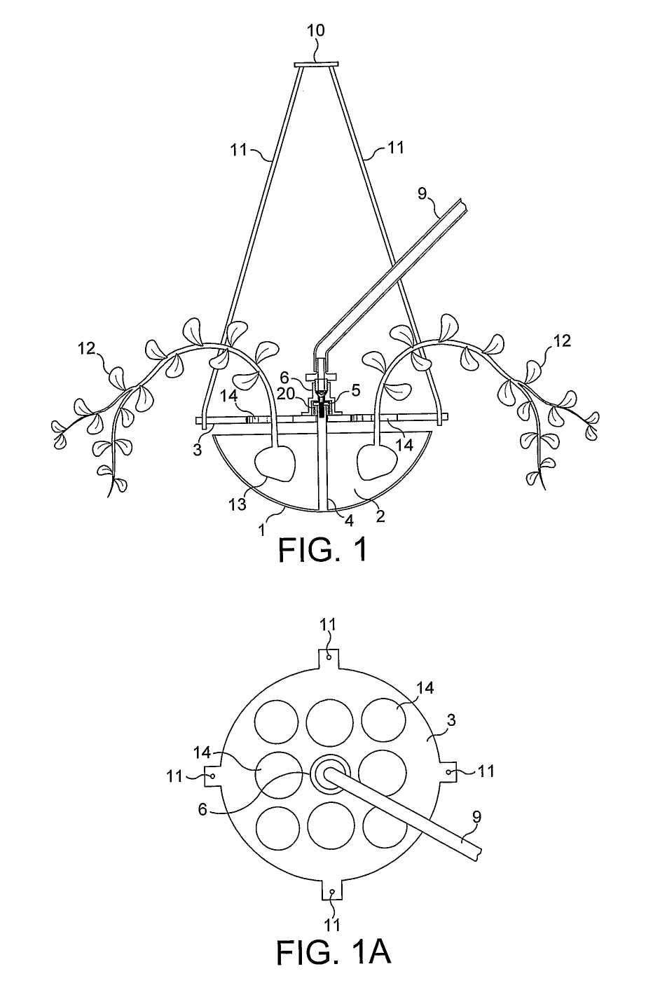

FIG. 1 shows a side elevation of an apparatus according to this invention,

FIG. 1a shows a plan view of the apparatus of FIG. 1,

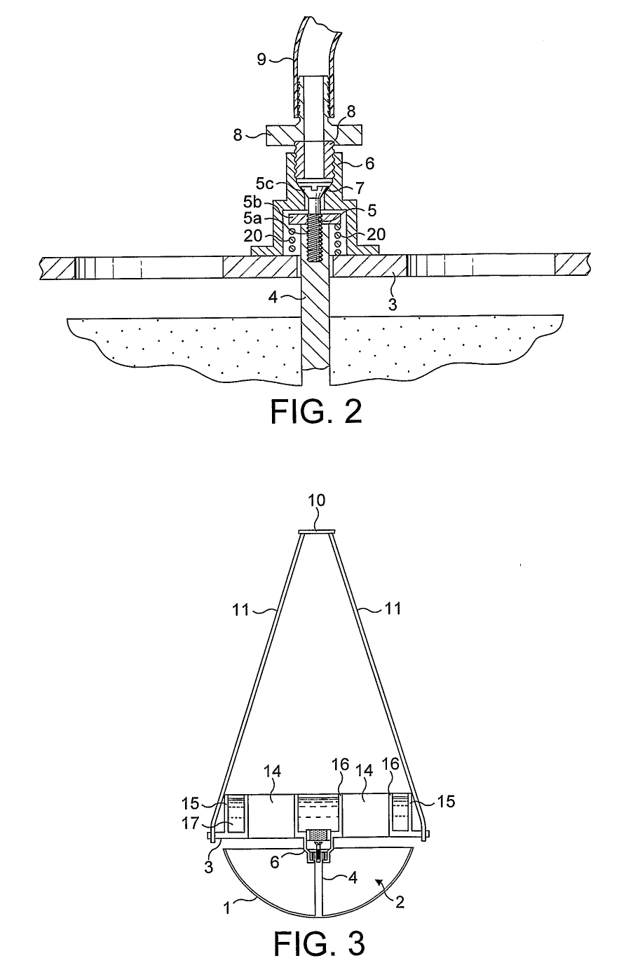

FIG. 2 shows an enlarged detail view of the valve assembly of FIG. 1,

FIG. 3 shows a side elevation of a modified and second embodiment of this invention,

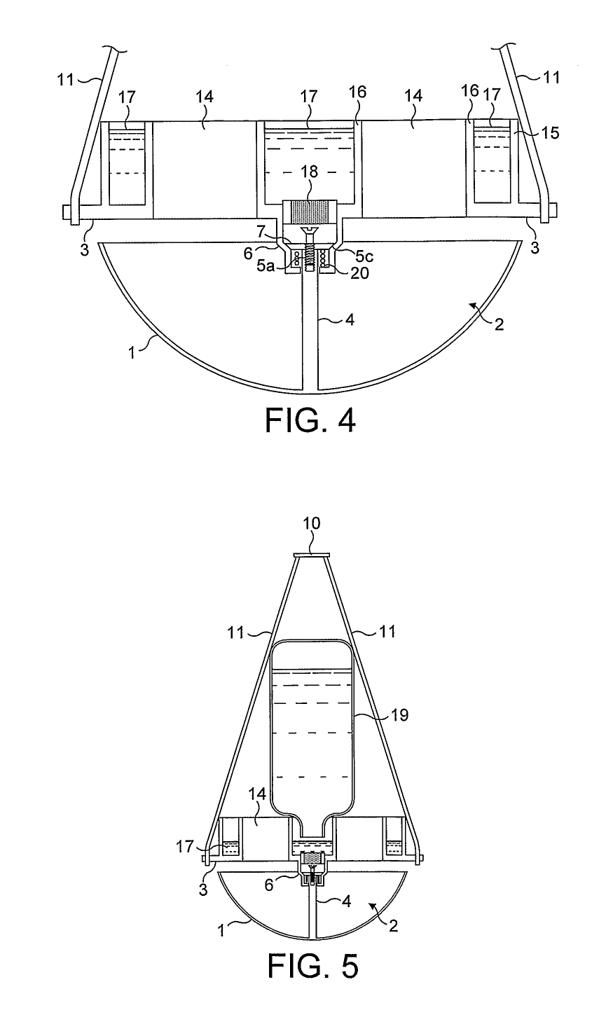

FIG. 4 shows in more detail the embodiment of FIG. 3, and

FIG. 5 shows a side elevation of a modification of the embodiment shown in FIGS. 3 and 4.

Referring to FIGS. 1, 1a and 2 of the drawings a container 1 is filled with a suitable growth medium such as a potting compost 2. The container 1 is suspended from a foliage support plate 3 by a bar 4 engaged and retained by a screw 5 (FIG. 2). A spring 20 is located between a threaded flange 5b located on the screw 5 and the plate 3 thus supporting the bar 4 against downward displacement. The screw 5 can be adjusted relative to the flange 5b by means of the threaded connection 5a which also connects the screw with the rod 4. The tapered head 5c of the screw 5 forms a valve which closes against a tapered valve seat 7 located in a valve body 6 which is rigidly attached to the plate 3. The flange 5b is adjusted on the screw 5 to provide for setting the valve closure point after a chosen quantity of water has been supplied to the container as determined by the weight. A hose union 8 provides for the attachment of a hose 9 to the valve body 6 and forms the means of supplying water from a container or from a source of supply.

The plate 3 is supported by a wall or ceiling bracket 10 by means of suspension rods, chains or cables 11.

In an alternative arrangement the suspension plate 3 can be supported on the rim of a container which then surrounds the freely suspended plant container 1.

In use plants 12 are added to the assembly through holes 14 in the plate 3 and the plant root ball 13 is embedded within the potting compost 2. When the potting compost contains a defined quantity of water, which may be the saturation point of the container, the spring 20 will be compressed under the added weight and, subject to correct adjustment of the screw 5 relative to the flange 5b, the valve assembly 5c, 6 and 7 will shut off the water feed. As the compost in the container dries out the weight will reduce and the valve will commence opening.

In this arrangement, and in accordance with this invention, the plant foliage is supported on the upper surface of the plate 3 and thus the bulk of the foliage weight increase is supported by the plate and does not contribute to the weight of the container 1 and planted medium.

In a further development of this invention and as shown in FIGS. 3 and 4, the plate forms a water reservoir. In this arrangement the rim of the plate has a peripheral water containment wall 15 and each of the planting holes 14 also includes a peripheral water containment wall 16 forming a reservoir on top of the plate for a water supply 17. The valve arrangement operates in a similar way to that of the embodiment of FIG. 1 but with the valve body 6 now located beneath the plate 3. A filter 18 is included in this arrangement to prevent particles entering the valve.

FIG. 5 shows a further development of the embodiment shown in FIGS. 3 and 4 wherein an inverted bottle 19 provides for longer periods between replenishment of the reservoir. The water from the bottle will only flow into the reservoir 17 when the water level in the reservoir drops below the bottle opening. The bottle may be loosely attached to the reservoir or suspended from the wall or ceiling bracket 10 or the rods 11.

In summary a preferred version of plant watering apparatus has a container 1 filled with a suitable growth medium 2 and is attached to a foliage support plate 3 by a bar 4 operatively coupled with a spring loaded water control valve 6. Decreasing weight of the container opens the valve to feed water to the container 1. The plate 3 is supported by a wall or ceiling bracket 10 by means of suspension rods 11. Plants 12 are added through holes 14 in the plate 3 and the plant root ball 13 is embedded within the medium 2 with the plant foliage overlying the plate 3. When sufficient water is present in the container 1 the spring loaded valve 6 will be closed. As the compost in the container dries out the weight will reduce and the valve will commence opening. The foliage is supported by the plate 3 and foliage growth will not significantly add to the weight of the container and thus will not affect the operating point of the valve over extended periods of time.

1. A plant watering apparatus wherein a plant container is associated with valve controlling the flow of water to the container according to a change in container weight, characterised by the provision of a plant foliage support member whereby in use a greater part of the weight of plant foliage is carried by the support member and does not contribute to the weight of the container.

2. A plant watering apparatus according to claim 1, wherein the plant foliage support member comprises an apertured plate through which foliage from plants in the container may pass such that a greater part of the weight of the foliage is carried by the plate such that neither the foliage nor the plate will contribute to the weight of the container.

3. A plant watering apparatus according to claim 1, wherein the plant container, or a supporting member for such a container, is suspended and operatively associated with the valve means such that the valve is opened to permit water flow to the container as the container becomes lighter due to water loss.

4. A plant watering apparatus according to claim 1, wherein the plant foliage support member is mounted or suspended independently of the container.

5. A plant watering apparatus according to claim 1, wherein the container is suspended from the plant foliage support member in a manner whereby relative displacement actuates the water control valve.

6. A plant watering apparatus according to claim 1, wherein the valve is mounted on the container or on the plant foliage support member.

7. A plant watering apparatus according to claim 1, wherein the plant foliage support is adapted to be supported or suspended from a fixed structure

8. A plant watering apparatus according to claim 1, wherein the valve is fed with water through a pipe from a supply or from a water container mounted on the plant foliage support member.

9. A plant watering apparatus according to claim 1, wherein the container is suspended from a rod operatively coupled with the valve located within a housing on the plant foliage support member.

10. A plant watering apparatus according to claim 1, wherein the container is supported through spring element permitting displacement, relative to the plant foliage support member, according to the container weight.

11. A plant watering apparatus according to claim 1, wherein the spring element is an integral part of the valve means.

12. A plant watering apparatus according to claim 1, wherein the operative points of opening and closing of the valve are adjustable.

13. A method of watering a plant in a container in which method a water flow valve controls flow of water to the container in response to a change in the weight of the container, the method including the step of supporting plant foliage such that the increasing weight thereof is not borne by the container.

14-15. (canceled)
